(19) United States
(12) Patent Application Publication
(10) Pub. No.: US 2008/0293458 A1
(43) Pub. Date: Nov. 27, 2008

(54) PADS FOR IMPROVED MANUAL GRIP OF A PORTABLE ELECTRONIC DEVICE

(76) Inventor: VIRGNIA E. FOSTER, Richmond Heights, MO (US)

Correspondence Address: CHARLES C. MCCLOSKEY, 763 S. NEW BALLAS ROAD STE. 170, ST. LOUIS, MO, 63141, US

(21) Appl. No.: 12/101,730

(22) Filed: Apr. 11, 2008

Related U.S. Application Data
(60) Provisional application No. 60/911,763, filed on Apr. 13, 2007.

(51) Int. Cl. H04M 1/00

(52) U.S. Cl. 455/575.1

(57) ABSTRACT

Pads provide an improved manual grip upon a portable electronic device, such as a cell phone, where at least one pad adheres to the casing of the cell phone, and upon an adjacent edge. When gripping a cell phone, a user generates friction between the hand of the user and the casing to provide the grip to open a folded cell phone. When a user's fingers are slick, grip upon the casing is reduced and dropped cell phones may occur. This invention has a pad upon the front of the cell phone that extends over a portion of the sides and alternatively a pad upon the rear of the cell phone that may also extend over the sides. The extensions upon the sides provide a gripping surface for the user's thumbs and palm. As users can be either left or right handed, the pads can extend upon both sides.

### CROSS REFERENCE TO RELATED APPLICATION

This non-provisional application claims priority to the provisional application Ser. No. 60/911,763 filed on Apr. 13, 2007 and commonly owned by the same inventor.

### BACKGROUND OF THE INVENTION

The pads for improved manual grip of a portable electronic device generally relate to device casings and more specifically to a pad located upon the device and shaped for a palm of a hand. The present invention strengthens the grip of a user upon a portable electronic device.

In the last thirty years, portable electronic devices have proliferated from their humble origins. Early portable telephones descended from military field phones and had a bulky shape commonly called a brick. Early portable phones had a telescoping antenna that extended from one end and sometimes required two hands to hold it near a person's mouth and ear. In the late 1980s and early 1990s, mobile subscriber radio telephones developed and portable telephones became bag phones, car phones, and cell phones. As portable electronic devices evolved, they became smaller and have more features.

Cell phones have become ubiquitous and ever present while becoming sleeker, slimmer, smoother, and smaller. The small size of cell phones allows them to fit readily into pockets, purses, bags, and other containers. The present small size and small buttons of cell phones make gripping and using a cell phone a challenge for some persons. Additionally, people use a cell phone while performing other tasks, commonly called multitasking. Multitasking, such as using a computer along with a cell phone, often leaves one hand to hold a cell phone. Multitasking also includes driving a motor vehicle which again requires at least one hand for both the steering wheel and the cell phone. Often a person's less dominant hand holds the cell phone while the dominant hand operates another device. A position in the less dominant hand, a preoccupied user of a cell phone, and the slim small size of cell phones make cell phones prone to dropping. A dropped cell phone may have a cracked display, or cease working. An inoperable cell phone may lead to an insurance claim if the cell phone user has a policy or to a displeased user who must purchase a replacement phone.

### DESCRIPTION OF THE PRIOR ART

Over the years, others have sought to protect cell phones from damage during and after dropping. The other inventions came in various forms yet few improved the grip of a person upon a casing as in the present invention. The other inventions had various guards and cushions as shown in the following patents.

The patent to Laurikka, U.S. Pat. No. 6,608,996 shows a device cover, primarily for cell phones from Finnish inventors. This cover contains an ink within the plastic that has charged particles. The ink responds to an electromagnetic signal and changes the color of the cover. A color change appears useful where the cell phone may not ring or vibrate. However, this patent is not the present invention. Though this patent discloses a dot, or microcapsule pattern, the dots appear flush or upon the surface of the cover. The dots do not appear able to absorb the impact of dropping a cell phone.

The patent to Ragner, U.S. Pat. No. 7,059,182 illustrates an unusual protective system for electronic devices, namely cell phones. This patented device has sensors that detect acceleration, or free fall, and that trigger forceful deployment of resilient arms from a cell phone, an active response to a drop. At impact, the arms absorb the deceleration of the dropped cell phone thus preventing damage.

The application to Wu, No. 2002/0137474 discloses a fabric cover embedded with crystals for a cell phone to protect cell phone users from the radiation of the cell phone. The crystals can be of various sizes and the cover secures to the cell phone with Velcro®. FIG. 3 also shows the crystals upon the sides of a cell phone.

The patent to Humphreys et al., U.S. Pat. No. 6,731,913 has another patent for a cell phone cover. This cover is generally made of an elastomer, a flexible rubber like substance, and primarily for the front of a cell phone. The patent also discloses a second cover for the rear of the cell phone and an outer band that binds the front and rear covers upon the cell phone. The front cover has keys that allow a user to activate the buttons on a cell phone within the cover. The elastomeric cover of this patent protects a cell phone from incidental contact with hard surfaces.

The published application to Brouard et al., No. 2005/0003723 shows a more durable felt pad for furniture legs. This pad has two surfaces, an upper surface with an injected or infused adhesive, not the double sided tapes on the market, and a lower surface with a felt or soft material. The adhesive bonds the pad to a furniture leg to resist shear forces when the leg moves across a surface.

The published application to Wood et al., No. 2005/0181745 has a housing that fits an entire cell phone. Upon closing of the housing, the housing provides water and dust protection for a cell phone contained within. The housing also has components that allow operation, and even hands free use, of the cell phone inside of the closed container.

The patent to Jung, U.S. Pat. No. 6,999,803, has a common flip style cell phone with an uncommon group of buffers. The buffers cushion the flip lid or folder from impact with the main body of the cell phone. The buffers are described singly, in pairs, or in a plurality. The buffers are also described as made of rubber.

The patent to Onda, U.S. Pat. No. 7,050,841 shows a protective enclosure for a device similar to an IPOD®. The enclosure protects the device from inadvertent dropping yet has openings to access the display screen and controls of the device. The enclosure fits tightly upon the device and provides lengthwise ribs to absorb shock.

The publication to Azumi et al., No. US2006/0110608, describes an impact absorbing sheet located within laptop display screens, overhead projectors, and the like. The sheet has a generally planar form made of rubber with optical translucent properties. Upon one face of the sheet, an adhesive impregnates the sheet and secures the sheet to a surface within the display equipment.

The present invention seeks to overcome the disadvantages of the prior art and provide additional advantages not heretofore shown. As the present invention serves many purposes, it accommodates the restrictions of each. The present invention has at least one pad that adheres to a front or rear, and a side of a portable electronic device, particularly a cell phone. The pad improves the grip of the palm and thumb of a person holding the cell phone or other device. The need to reduce incidential dropping of cell phones drove the design of the present invention. Though cell phones have been described, the present invention can be used upon other devices such as portable data assistants or PDA, Blackberries®, Blackjacks®, portable tape recorders, camcorders, and other devices.

### SUMMARY OF THE INVENTION

Generally, the pads for improved manual grip upon a portable electronic device provide at least one pad upon a wide surface of the casing of a portable electronic device, such as a cell phone, and upon an adjacent edge of a cell phone. A cell phone generally has an upper half folded upon a lower half when not in use, and the upper half generally has an LCD screen while the lower half also has the charging port. When gripping a cell phone to unfold, a user must generate friction between the fingers and palm of the user and the casing of the cell phone. Generally, the friction between the user's skin and the casing provides the grip to open the upper half from the lower half. When a user's fingers are slick from food, perspiration, or moisture, the user's grip upon the casing is reduced, often causing a drop of the cell phone. The present invention provides a pad upon the front of the upper half below the screen that extends over the sides of the upper half and a pad upon the lower half above the charging port that also extends over the sides of the lower half. The extensions upon the sides provide a gripping surface for the user's thumbs when opening the cell phone. As users can be either left or right handed, the pads of the present invention extend upon both sides.

There has thus been outlined, rather broadly, the more important features of the invention in order that the detailed description thereof that follows may be better understood and that the present contribution to the art may be better appreciated. The present invention also includes raised strips for a mechanical grip or a three dimensional grip; an adhesive, hook and loop fastener, or a loop around the upper half or lower half of the cell phone to attach the pads to the cell phone; and, integrating the pads with the casing by a manufactured recess in the cell phone casing.

Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved pad for manual grip of a portable electronic device.

Another object is to provide such a pad for manual grip that increases the friction between a user's skin and the casing of a cell phone.

Another object is to provide such a pad for manual grip that heightens the grip of both the thumb and the palm of a user with the casing of a cell phone.

Another object is to provide such a pad for manual grip that reduces the incidences of dropped cell phones.

Another object is to provide such a pad for manual grip that has a low cost of manufacture so the consuming public may readily purchase and install the pad upon existing electronic devices.

Another object is to provide such a pad for manual grip that adheres readily to the various metallic and polymer casings of electronic devices.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 shows an isometric view of the present invention placed upon a portable electronic device;

FIG. 2 describes a side view of the present invention when installed;

FIG. 3 shows a perspective view of the present invention installed upon a device with an upper half of lesser length than the bottom half;

FIG. 4 describes a top view of the present invention when installed upon the shortened upper half of FIG. 3;

FIG. 5 shows a bottom view of the present invention when installed on the lower half of the device of FIG. 3; and,

FIG. 6 has a side view of the present invention when installed upon the device of FIG. 3.

The same reference numerals refer to the same parts throughout the various figures.

### DESCRIPTION OF THE PREFERRED EMBODIMENT

The present art overcomes the prior art limitations by providing a pad 1 that joins to an existing cell phone P, equipment, or other portable electronic device. For convenience, usage of the invention upon a cell phone will be described however, the invention can apply to other portable electronic devices. The pad augments and strengthens the surface grip of a person's hand and fingers upon the casing of a cell phone. In FIG. 1, a cell phone has an upper half F, or front, with a screen S that displays information. The upper half pivotally connects by a hinge H to the lower half R, or back, that generally contains the battery of the cell phone and the charging port C. When unfolded, the upper half provides the speaker placed near the user's ear and the lower half provides the microphone placed near the user's mouth. The lower half also has a keypad for entry of numbers and letters into the cell phone. The upper half F has a longitudinal edge or side G that spans from the hinge H for the length of the cell phone. The lower half R also has a longitudinal edge K. The pad 1 applies to the upper half F generally below the screen S to the lateral end of the upper half opposite the hinge H. The pad has a width 2, as shown by the line bb, and a length 3, as shown by the line aa. The pad is generally planar in extent and of a thickness less than 0.0625 inch. In the preferred embodiment, the pad is generally rectangular in shape with rounded corners for comfort and resistance to peeling of the pad from the casing of the cell phone.

Proximate at least one longitudinal edge G, the pad 1 has at least one ear 6 that extends over the edge from the front of the upper half F to the longitudinal edge G. The ear has less length than the length 3 of the main portion of the pad upon the upper half F, preferably less than 20%. The ear generally has the same thickness as the remainder of the pad and extends for at least 75% of the depth of the upper half on the longitudinal edge G. The ear and the pad are generally of the same material and continuous.

FIG. 2 further illustrates the positioning of ears 6 upon the longitudinal edges G, K of the upper half F and the lower half R, respectively. As before, the pad 1 upon the upper half F has an ear 6 that extends upon the longitudinal edge G generally opposite the hinge H and the screen S. The ear is an extension of the lengthwise edge 4 of the pad. And the opposite lengthwise edge is shown as at 5. Opposite the upper half F, the phone P has the lower half R that also has a longitudinal edge K. The lower half R can also have a camera shutter L or other peripheral, generally proximate the hinge. In this figure, a second pad 8 is positioned upon the lower half R, generally for the full length and width of the lower half. The second pad has at least one ear 7 that extends upon the longitudinal edge K. As before, this ear 7 is a continuous extension of the second pad 8 along a portion of the length of the pad, approximately 20%. The length of an ear, 6, 7, is generally the width of a person's thumb for the thumb is used to grip either half of the phone P during opening and closing.

Another embodiment of the pad 1 of the present invention is shown in FIG. 3 where a cell phone P has an upper half F that extends for less than the length of the phone P. The upper half has a bottom portion B that is a component of the lower half R and has a screen S as before. This upper half F though has a camera lens, proximate the hinge, a logo, centered below the screen, and a speaker between the logo and the lateral edge of the upper half opposite the screen. In this alternate embodiment, the third pad 9 is located upon the upper half below the screen and has apertures 9a, 9b therethrough for the logo and speaker respectively. This embodiment has a fourth pad 10 located on the bottom portion component of the lower half R. Generally the third pad 9 and the fourth pad 10 have similar widths though the fourth pad 10 has a lesser length that the third pad 9 to fit upon the bottom portion. The third pad 9 though has an ear 6 extending from the pad outwardly partially along the length of one or both sides. The ear is proximate the speaker and extends over the longitudinal edge as at G.

And upon the lower half R, a fifth pad 11 adheres to the casing of the cell phone. The fifth pad in this embodiment extends from proximate the hinge H to generally below the aperture 9a for the logo. The fifth pad has a width generally proximate that of the cell phone and lacks ears. Separate from the fifth pad, a sixth pad 12 extends across the width of the lower half R and in length below a portion of the bottom component B. The sixth pad has an ear 13 extending partially outwardly from its length and upon the longitudinal edge K towards the aperture 9b for the speaker.

FIG. 4 shows the alternate embodiment of the pads from a top view of the upper half F. The third pad 9 adheres to the casing of the upper half, generally centered between the screen S and the separation of the bottom portion B of the lower half R. The third pad has pre-punched apertures 9a, 9b for the logo and speaker respectively of the cell phone. As before, an ear 6 extends towards the right side of the casing and down upon the longitudinal edge to assist a thumb in gripping the upper half for opening and closing of the cell phone. Opposite the upper half on the other side of the separation, this cell phone has a bottom portion B generally coplanar with the remainder of the upper half though a component of the lower half. The fourth pad 10 adheres to the bottom portion B generally coplanar with the third pad 9 upon the remainder of the upper half. The fourth pad generally occupies the majority of the surface of the bottom portion B and augments the grip of a user's palm and fingers when holding the bottom portion.

Turning the cell phone over, FIG. 5 shows the arrangement and positions of the fifth pad 11 and the sixth pad 12. The fifth pad generally occupies the upper portion of the lower half R from near the hinge H to approximately two thirds of the length of the lower half. In this embodiment, the fifth pad is shown with an inverted trapezoidal shape with the short base located towards the center of the cell phone and rounded corners. The fifth pad generally narrows in width away from the hinge. Spaced slightly away from the fifth pad, the sixth pad 12 occupies the width of the lower half and extends at least one ear 13, here showing two opposite ears, around and upon the longitudinal edge K. As before the ears serve to augment the grip of the fingers when grasping the lower half R. The sixth pad also generally narrows in width away from the hinge and avoids an input output port, or the charging port C, located near the sixth pad upon the rear half R.

Viewing FIG. 3 from the side, FIG. 6 shows another alternate embodiment of the pads of this invention. The third pad 9 extends partly along the upper half F away from the screen S and the hinge H and stops at the separation with the bottom component B. The third pad lacks the ears of previous embodiments in this view. The lack of ears kinesthetically guides a thumb to grip the lower half R during opening and closing of the cell phone. The fifth pad 11 extends from the hinge H upon the lower half R to generally below the screen or proximate the logo. The fifth pad spans across the width of the lower half in this alternate embodiment. Spaced away from the fifth pad and the hinge H, the sixth pad 12 spans the width of the lower half but does not reach to the end of the lower half opposite the hinge. The sixth pad 12 has at least one ear 13, here shown extending upon the right longitudinal side K of the lower half. The ear provides a guide to the thumbs and fingers of the user during opening and closing of the cell phone as during daily usage.

Though these embodiments are shown with various numbers and positions of pads, the present invention anticipates pads being located in further alternate ways to augment the grip of the user. Certain pads may become strips or dots to improve the grip upon the smooth casing of a cell phone. The strips, mutually parallel, are spaced apart upon the casing, often at an angle to the width of the casing. The friction between the edges of the strips and the skin of the user's palm and fingers improves the grip upon the cell phone.

The present invention also includes a method of protecting a cell phone or other electronic device. The method attaches at least one thin pad to the casing of a cell phone and provides an extension of at least one pad. The extension has greater width and an outwardly positioning upon a portion of a longitudinal edge of the cell phone. The extension assists the thumb in grasping the edge of the cell phone during folding and unfolding. The method further has one pad upon the upper half and one pad upon the lower half of the cell phone and each pad has an extension upon at least one of the longitudinal edges.

The pads attach to the casing using adhesives, cooperating hook and loop fasteners or Velcro®, an elastic band that encircles the casing and the pads, and attractive static charge between the pads and the casing, and like means of attachment.

Additionally, though a cell phone has been described in this specification, the present invention can be installed upon other hand held electronic devices such as Blackberries®, Palm® devices, and other PDAs. The cell phone previously described had two hinged halves, upper and lower. The present invention though attaches to various devices whether the devices fold or have a fixed shape. For devices of a fixed shape, the present invention operates by having a pad upon at least one face, front or back, of a device and the ear, or extension upon at least one side of the device.

From the aforementioned description, pads to improve manual grip upon hand held electronic devices have been described. The pads are uniquely capable of strengthening the grip of a user's hand upon a cell phone or other smooth casing device. The pads are a flexible and somewhat cushioning material that temporarily binds well with skin under various conditions of dampness. The pads and their various components may be manufactured from many materials, including but not limited to, felt, vinyl, thermo plastic resins, mastics, polymers, polyvinyl chloride, nylon, and composite fabrics.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A device for increasing the grip of a user upon a portable electronic device, said portable electronic piece having a front and an opposite back, said front and said back each having longitudinal edges parallel to the length of said portable electronic piece, comprising:
at least one pad adapting to attach to said portable electronic piece, said at least one pad having a thin planar shape, a perimeter edge, and a thickness substantially less than said portable electronic piece; and,
said pad having at least one ear extending laterally therefrom partially along said perimeter edge and upon at least one of said longitudinal edges.

2. The grip increasing device of claim 1 further comprising:
at least one pad upon said front; and,
at least one pad upon said back.

3. The grip increasing device of claim 2 including each of said pads having at least one ear extending laterally therefrom partially along an edge of said pad and upon at least one of said longitudinal edges.

4. The grip increasing device of claim 1 wherein said at least one pad adapts to attach to said portable electronic piece by one of adhesives, hook and loop fasteners, or static charge.

5. The grip increasing device of claim 3 wherein each of said at least one pads attaches to said portable electronic piece by one of adhesives, hook and loop fasteners, or static charge.

6. A device increasing the friction between the hand of a user and a piece of electronic equipment, said equipment having a front and an opposite back, said front and said back each having longitudinal edges parallel to the length of said equipment, comprising:
at least one pad having a thin planar shape, a perimeter edge, a thickness substantially less than said equipment, at least one ear extending laterally therefrom partially along said perimeter edge and upon at least one of said longitudinal edges; and,
said at least one pad adapting to attach to said equipment.

7. The friction increasing device of claim 6 further comprising:
said at least one pad having at least one aperture.

8. The friction increasing device of claim 6 further comprising six pads.

9. The friction increasing device of claim 6 wherein said at least one pad has a shape adapted to fit said equipment.

10. The friction increasing device of claim 9 further comprising:
said at least one pad having a trapezoidal shape.

11. The friction increasing device of claim 6 further comprising:
a first pad;
a second pad, spaced apart from said first pad;
a third pad;
a fourth pad, spaced apart from said third pad;
a fifth pad; and,
a sixth pad.

12. The friction increasing device of claim 6 further comprising:
at least two of said pads, each of said pads having an elongated shape and said pads being mutually parallel.

13. The friction increasing device of claim 6 further comprising:
at least three of said pads, each of said pads having a shape of a dot.

14. The friction increasing device of claim 6 further comprising:
said at least one pad attaching to said equipment by one of adhesives, hook and loop fasteners, or static charge.

15. A method of reducing dropping of a hand held electronic device by a user, said device having a front and an opposite back, said front and said back each having longitudinal edges, including:
attaching at least one thin pad to said device; and,
extending one of said pads outwardly from said device and upon one of said longitudinal edges.

16. The drop prevention method of claim 15 further including:
attaching one of said pads to said front and extending said pad upon one of said longitudinal edges of said front; and,
attaching one of said pads to said back and extending said pad upon one of said longitudinal edges of said back.

17. The drop prevention method of claim 16 further including:
said attaching of said pads by one of adhesives, hook and loop fasteners, or static charge.
